(19) United States
(12) Patent Application Publication
(10) Pub. No.: US 2017/0016247 A1
(43) Pub. Date: Jan. 19, 2017

(54) Reversible Handleset Spindle Actuator And Related Method And Kit

(71) Applicant: Ferco Architectural Hardware Inc., Laval (CA)

(72) Inventor: Guy GUILLEMET, Terrebonne (CA)

(21) Appl. No.: 14/797,793

(22) Filed: Jul. 13, 2015

(51) Int. Cl. E05B 3/00; E05B 15/02; E05B 15/00

(52) U.S. Cl. CPC E05B 3/00; E05B 15/0033; E05B 15/02

(57) ABSTRACT

A reversible handleset spindle actuator and related method and kit. The spindle actuator is configured to be installed in a handleset. A first thumb-operated lever receiver is positioned to be engaged by a thumb-operated lever connected to the exterior escutcheon of the handleset when the actuator is installed in the handleset configured for a right-handed position. A second thumb-operated lever receiver is positioned to be engaged by the thumb-operated lever when the actuator is installed in the handleset configured for a left-handed position. A spindle is provided for operating a latch mechanism and a rack and pinion mechanism is provided for rotating the spindle, from an initial position, in a first direction when the first thumb-operated lever receiver is moved longitudinally towards the spindle and rotating the spindle in a second direction when the second thumb-operated lever receiver is moved longitudinally towards the spindle.

### TECHNICAL FIELD

The present invention relates to handleset hardware components and, more particularly, to a thumb-operated handleset hardware components.

### BACKGROUND

A door handleset allows a door latch to be retracted when a thumb-operated lever is pushed on one face of the door. The door latch is also retracted when a handle or knob is turned on the other side of the door. An actuator in the body of the handleset comprises a spindle that connects to the latch mechanism. The actuator allows the thumb-operated lever to operate the door latch and thereafter return to its original position. The actuator also allows the handle or knob to operate the door latch. A spring-loaded component in the body of the handleset ensures that the handle or knob returns to its original position when released.

The actuator in the body of the handleset is directional, meaning that actuators configured differently are required depending on how the door is handed (i.e., whether the handleset is installed to the right side of the door or to the left side of the door). For instance, inventory of handlesets handed differently has to be maintained.

In some embodiments, the present invention addresses this limitation.

The spring-loaded component that returns the handle or knob to its original position when released is typically costly, more prone to failure and rather complex for what it is meant to accomplish.

In some embodiments, the present invention addresses this limitation.

When two handlesets are used side-by-side on double doors, only one is typically active and the other one is passive. Other scenarios may also require passive handlesets. A handleset specifically configured as a dummy (or passive handleset) is provided (e.g., for aesthetical reasons). For instance, inventory of handlesets prepared in dummy version has to be maintained.

In some embodiments, the present invention addresses this limitation.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a reversible handleset spindle actuator configured to be installed between an exterior escutcheon of a handleset and an interior escutcheon of the handleset. The reversible handleset spindle actuator comprises a first thumb-operated lever receiver positioned to be engaged by a thumb-operated lever connected to an exterior escutcheon of the handleset when the actuator is installed in the handleset configured for a right-handed position. The reversible handleset spindle actuator also comprises a second thumb-operated lever receiver positioned to be engaged by the thumb-operated lever connected to the exterior escutcheon of the handleset when the actuator is installed in the handleset configured for a left-handed position. The reversible handleset spindle actuator yet also comprises a spindle for operating a latch mechanism and a rack and pinion mechanism. The rack and pinion mechanism is for rotating the spindle, from an initial position, in a first direction when the first thumb-operated lever receiver is moved longitudinally towards the spindle and rotating the spindle, from the initial position, in a second direction different from the first direction when the second thumb-operated lever receiver is moved longitudinally towards the spindle.

Optionally, the reversible handleset spindle actuator may further comprise a return mechanism for returning the spindle to the initial position when no pressure is exerted on the first thumb-operated lever receiver and when no pressure is exerted on the second thumb-operated lever receiver. The return mechanism may comprise two springs oppositely mounted on a central wall of a casing of the spindle actuator, each spring respectively engaging one of two receiving portions of a pinion of the rack and pinion mechanism.

The spindle of the reversible handleset spindle actuator may optionally comprise an active wing, on a one half of a needle portion thereof, for allowing a handle of the handleset connected on the interior escutcheon to actively rotate the spindle while allowing the handle to remain passive when an active one between the first and second thumb-operated lever receivers is moved longitudinally towards the spindle.

Two symmetrical openings may be provided through the reversible handleset spindle actuator for allowing a protuberance in the exterior escutcheon to get within a first one of the two openings when the spindle actuator is installed in the handleset, thereby preventing an inactive one between the first and second thumb-operated lever receivers from moving longitudinally towards the spindle. As a further option, a second one of the two openings may allow a screw to be inserted towards a receiving socket in the exterior escutcheon for providing a dummy configuration of the exterior escutcheon whereby both the first and second thumb-operated lever receivers are prevented from moving longitudinally towards the spindle.

A second aspect of the present invention is directed to method for positioning a reversible handleset spindle actuator in a handleset for providing a required handed configuration for the handleset. The method comprises receiving the handleset. The reversible handleset spindle actuator may be pre-installed for providing a first handed configuration for the handleset or the handleset spindle actuator may be uninstalled. The spindle actuator comprises a first thumb-operated lever receiver for rotating a spindle of the spindle actuator in a first direction and a second thumb-operated lever receiver for rotating the spindle in a second direction different from the first direction. The method also comprises, when the spindle actuator is pre-installed in the first handed configuration different from the required handed configuration, unscrewing the spindle actuator from the exterior escutcheon of the handleset. The method then follows with rotating the spindle actuator over the exterior escutcheon along the spindle axis for providing the required handed configuration and, once properly positioned, screwing the spindle actuator into the exterior escutcheon.

A third aspect of the present invention is directed to a handleset kit comprising an interior escutcheon, an exterior escutcheon and a reversible handleset spindle actuator configured to be installed between the exterior escutcheon and the interior escutcheon. The reversible handleset spindle actuator comprises a first thumb-operated lever receiver positioned to be engaged by a thumb-operated lever connected to an exterior escutcheon of the handleset when the actuator is installed in the handleset configured for a right-handed position. The reversible handleset spindle actuator also comprises a second thumb-operated lever receiver positioned to be engaged by the thumb-operated lever connected to the exterior escutcheon of the handleset when the actuator is installed in the handleset configured for a left-handed position. The reversible handleset spindle actuator yet also comprises a spindle for operating a latch mechanism and a rack and pinion mechanism. The rack and pinion mechanism is for rotating the spindle, from an initial position, in a first direction when the first thumb-operated lever receiver is moved longitudinally towards the spindle and rotating the spindle, from the initial position, in a second direction different from the first direction when the second thumb-operated lever receiver is moved longitudinally towards the spindle.

Optionally, the reversible handleset spindle actuator of the kit may further comprise a return mechanism for returning the spindle to the initial position when no pressure is exerted on the first thumb-operated lever receiver and when no pressure is exerted on the second thumb-operated lever receiver. The return mechanism may further comprise two springs oppositely mounted on a central wall of a casing of the spindle actuator, each spring respectively engaging one of two receiving portions of a pinion of the rack and pinion mechanism.

The spindle of the reversible handleset spindle actuator of the kit may further comprise an active wing, on a one half of a needle portion thereof, for allowing a handle of the handleset connected on the interior escutcheon to actively rotate the spindle while allowing the handle to remain passive when an active one between the first and second thumb-operated lever receivers is moved longitudinally towards the spindle.

Optionally, the reversible handleset spindle actuator of the kit may further comprise two symmetrical openings provided therethrough for allowing a protuberance in the exterior escutcheon to get within a first one of the two openings when the spindle actuator is installed in the handleset, thereby preventing an inactive one between the first and second thumb-operated lever receivers from moving longitudinally towards the spindle. A second one of the two openings may further allow a screw to be inserted towards a receiving socket in the exterior escutcheon for providing a dummy configuration of the exterior escutcheon whereby both the first and second thumb-operated lever receivers are prevented from moving longitudinally towards the spindle.

The interior escutcheon of the kit may optionally further comprise a first lock screw receiver for receiving a lock screw for preventing an interior handle actuator from moving. The interior escutcheon may yet also further comprise a second lock screw receiver for preventing an interior lock knob from moving. The interior escutcheon may also further comprise a plate comprising one or more indications aligned with at least one of the first and second lock screw receivers.

### BRIEF DESCRIPTION OF THE DRAWINGS

Further features and exemplary advantages of the present invention will become apparent from the following detailed description, taken in conjunction with the appended drawings, in which:

FIG. 1 is a lateral view of an exemplary handleset 1000 in accordance with the teachings of the present invention;

FIG. 2A, FIG. 2B, FIG. 2C and FIG. 2D, hereinafter referred to concurrently as FIG. 2, are different views of an exemplary spindle actuator in accordance with the teachings of the present invention;

FIG. 3A, FIG. 3B and FIG. 3C, hereinafter referred to concurrently as FIG. 3, are different views of an exemplary spindle actuator received in an exemplary interior escutcheon in accordance with the teachings of the present invention;

FIG. 4A and FIG. 4B, herein referred to concurrently as FIG. 4, are back views of a handleset incorporating an exemplary spindle actuator in different handed configurations in accordance with the teachings of the present invention;

FIG. 5A, FIG. 5B and FIG. 5C, herein referred to concurrently as FIG. 5, are different interior views of an exterior escutcheon in accordance with the teachings of the present invention;

FIG. 6A and FIG. 6B, herein referred to concurrently as FIG. 6, are perspective views of an exemplary interior escutcheon of a handleset in accordance with the teachings of the present invention;

FIG. 7 is a perspective view of an exemplary handleset in accordance with the teachings of the present invention;

FIG. 8 is a flow chart of a first exemplary method in accordance with the teachings of the present invention; and

FIG. 9 is a flow chart of a second exemplary method in accordance with the teachings of the present invention.

### DETAILED DESCRIPTION

In a first set of embodiments, the present invention addresses the need for a spindle actuator in the body of the handleset that can provide the two handed actuator configurations (i.e., for the handleset to be installed to the right side of the door (right-handed or RH) or to the left side of the door (left-handed or LH) as perceived from the exterior). Specifically, the spindle actuator in accordance with the teachings of the first set of embodiments can be installed in the body of the handleset in a right-handed (RH) configuration or a left-handed (LH) configuration without having to modify the actuator itself, but by modifying the position of the spindle actuator within the body of the handleset, which may be accomplished at the time of installation of the handleset rather than at the time of manufacture of the handleset. A method for modifying the position of the spindle actuator within the body of the handleset is also provided. In some embodiments, the spindle actuator also allows the door latch to be operated from the thumb-operated lever without movement of an interior door knob or handle.

In a second set of embodiments, the present invention addresses the need for a simplified and reliable solution to return the handle or knob to its original position when released. Specifically, in accordance with the teachings of the second set of embodiments, an interior escutcheon is designed with embedded support structures to receive a simple torsion spring for returning the handle or knob to its original position when released, thereby replacing the typical complete spring-loaded component for the same purpose.

In a third set of embodiments, the present invention addresses the need for a handleset that can easily be converted from an active handleset to a passive handleset. Specifically, in accordance with the teachings of the third set of embodiments, moving parts located within the body of the handleset are designed to allow one or more screws to be easily added to restrict or eliminate movement. Such screw(s) can be added at the time of installation of the handleset rather than at the time of manufacture of the handleset. For instance, the deadbolt interior knob mechanism, the interior handle mechanism and the spindle actuator may be configured to allow passage of a locking screw towards their respective escutcheon.

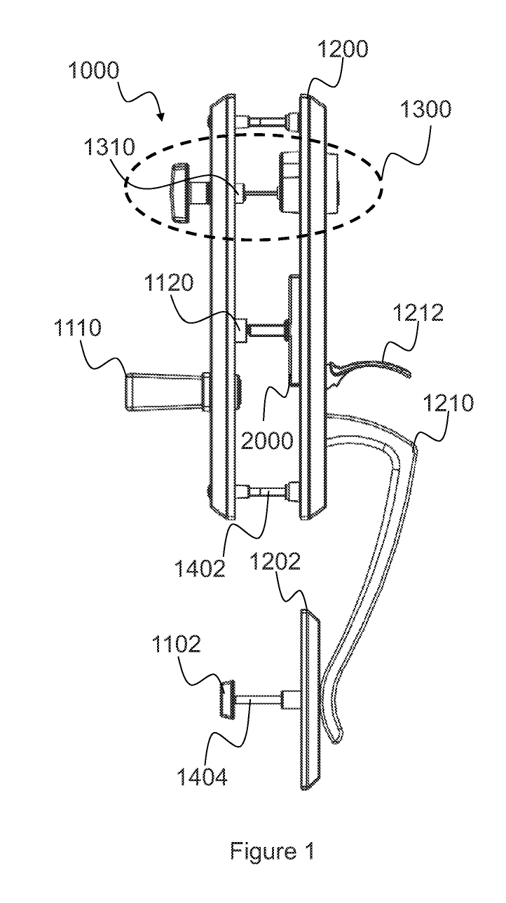

Reference is now made to the drawings in which FIG. 1 shows a lateral view of an exemplary handleset 1000 in accordance with the teachings of the present invention. Skilled persons will understand that the term handleset has been chosen to describe a door handle comprising a vertical handgrip with a thumbpiece or thumb-operated lever and, typically, a keylock on an exterior side and a knob or handle and, typically, a lock knob on an interior side. The handleset may also be alternatively referred to as a gripset or grip-set. It will also be readily understood that the teachings of the present invention are not limited to handlesets installed on exterior doors and that the terms interior and exterior are only used for ease of understanding.

The handleset 1000 allows operation of a latch mechanism (not shown), which may be a single point system or a multipoint door gear system such as the SECURY AUTOMATIC system from Gretsch-Unitas Group Gmbh. Different latch mechanisms may be made compatible with the teachings of the present invention without affecting the present invention. The handleset 1000 depicted in the example of FIG. 1 comprises internal escutcheons 1100 and 1102 and external escutcheons 1200 and 1202. In some embodiments, a locking mechanism 1300 may be provided. A vertical handgrip 1210 with a thumb-operated lever 1212 links the escutcheons 1200 and 1202. A handle is positioned on the escutcheon 1100. In the different views, the escutcheons 1100, 1102, 1202 and/or 1202 are depicted in the shape of rectangles and/or ovals. Skilled person will readily acknowledge that the shape is not relevant to the present invention and may be chosen for aesthetical reasons without affecting the present invention. Likewise, single escutcheon(s) (not shown) could be provided that overlaps the escutcheons 1100 and 1102 and/or the escutcheons 1200 and 1202. Conversely, the escutcheons 1100 and/or 1200 may be split into multiple escutcheons, thereby providing separate escutcheon(s) for the locking mechanism 1300. In the depicted example, screws 1400, 1402 and 1404 are used to install the handleset on a door (not shown), which may vary in thickness without affecting the innovative aspects of the present invention. More or less screws may be required depending on the chosen escutcheon configuration. A spindle actuator 2000 is provided between the internal escutcheon 1100 and the external escutcheon 1200, which is also referred to as the body of the handleset 1000.

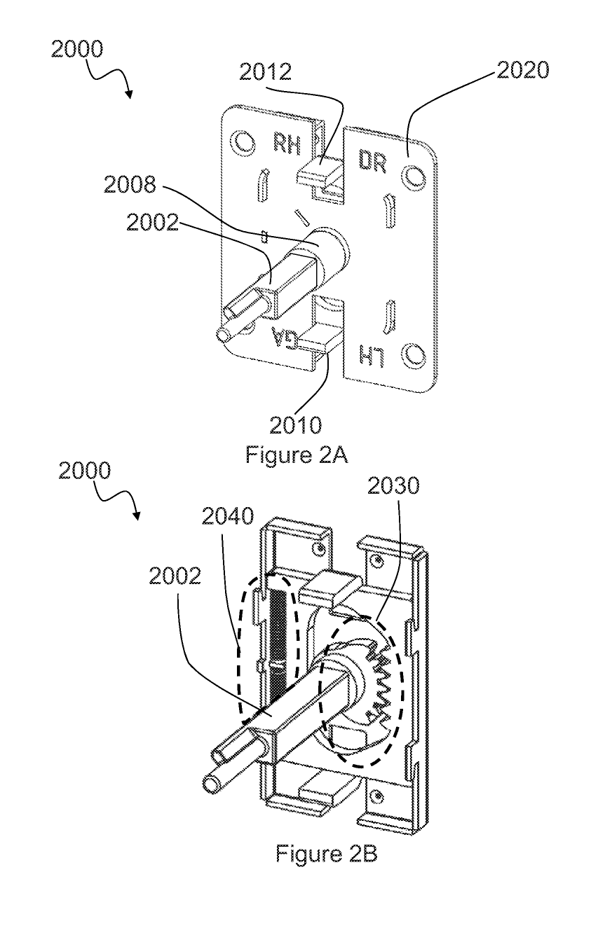

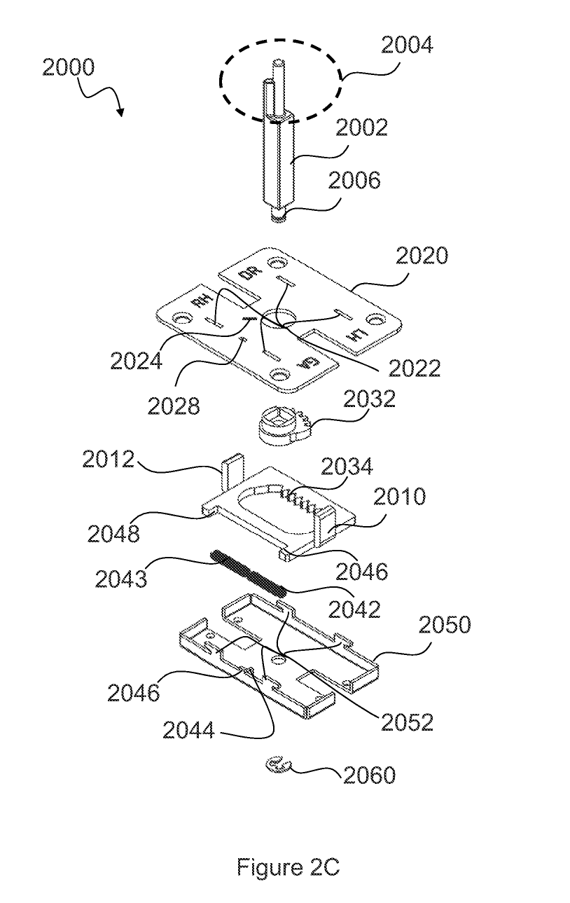

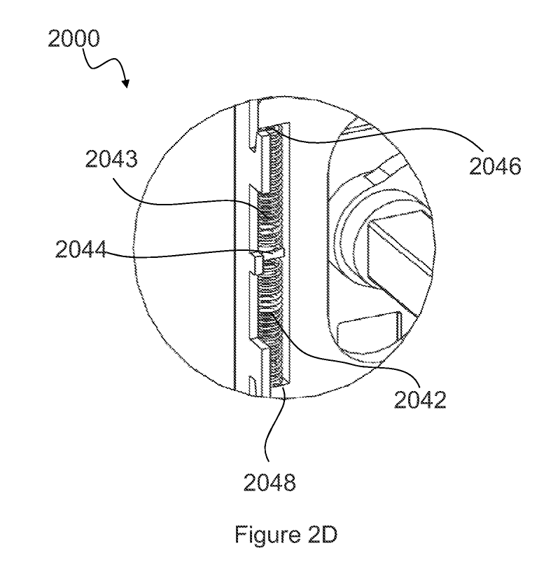

FIG. 2A, FIG. 2B, FIG. 2C and FIG. 2D, hereinafter referred to together as FIG. 2, provides different views of the exemplary spindle actuator 2000, in accordance with a first set of embodiments of the present invention. FIG. 2A is a perspective view of the spindle actuator 2000. FIG. 2B is a perspective view of the spindle actuator 2000 without a plate 2020. FIG. 2C is an exploded view of the spindle actuator 2000. FIG. 2D is a close-up partial view a return mechanism 2040 of the spindle actuator 2000.

In the example of FIG. 2, the spindle actuator 2000 is reversible and is configured to be installed between the exterior escutcheon 1200 and the interior escutcheon 1100 of the handleset 1000. The spindle actuator 2000 comprises a spindle 2002 for operating the latch mechanism (not shown). The spindle actuator 2000 also comprises two thumb-operated lever receivers 2010 and 2012. The first thumb-operated lever receiver 2010 is positioned to be engaged by the thumb-operated lever 1212 connected to the exterior escutcheon 1200 of the handleset 1000 when the spindle actuator 2000 is installed in the handleset 1000 configured for a right-handed position.

The second thumb-operated lever receiver 2012 is positioned to be engaged by the thumb-operated lever 1212 when the spindle actuator 2000 is installed in the handleset 1000 configured for a left-handed position.

A plate 2020 is depicted with screw holes for installing the spindle actuator 2000 in the handleset 1000. In the depicted example, the spindle actuator 2000 is configured for installation in the handleset 1000 above the thumb-operated lever 1212, which implies that the bottom receiver between the first and second thumb-operated lever receivers 2010 and 2012 is active. Other means of installation could be provided without affecting the present invention. Optionally, markings may be provided on the plate 2020, which may be used to correctly align the spindle 2002 (i.e., using notch 2024 useful during manufacturing and/or for quality assurance purposes) and/or explicitly indicating which side of the spindle actuator 2000 is to be aligned with the top of the handleset 1000 by using letters RH (DR) and/or LH (GA). Likewise, in order to ensure that the plate 2020 itself is correctly aligned with the casing 2050, an alignment opening 2028 may be provided to receive an alignment tab 2046 from the casing 2050. Markings and alignment means may also additionally or alternatively be provided on the casing 2050 and/or the spindle 2002. While optional, the markings may be used to prevent or reduce the likelihood of manufacturing and installation problems. Other means of ensuring proper alignment and installation may be provided, including relying on the reliability of the manufacturing process and knowledge of the installers.

FIG. 2B shows the spindle actuator 2000 with the plate 2020 removed, for better illustrating one embodiment of the first set of embodiments. A rack and pinion mechanism 2030 is provided comprising a pinion 2032 connected (or formed integrally) with the spindle 2002 and a rack 2034 formed integrally (or connected) with the first and second thumb-operated lever receivers 2010 and 2012. When the pinion 2032 is provided as a distinct part (as depicted), it is possible to replace the spindle 2002 on a spindle actuator 2000 by removing the C-clip 2060. This may be advantageous to support multiple spindle 2002 lengths, e.g., for different door thicknesses.

The rack and pinion mechanism 2030 is configured in such a way that when the first thumb-operated lever receiver 2010 is moved longitudinally towards the spindle 2002, the spindle 2002 is rotated, from an initial position (as depicted on FIG. 2), in a first direction. The rack and pinion mechanism 2030 is also configured in such a way that when the second thumb-operated lever receiver 2012 is moved longitudinally towards the spindle 2002, the spindle 2002 is rotated from the depicted initial position, in a second direction different from the first direction. In the depicted example, when the thumb-operated lever 1212 is operated with the spindle actuator 2000 installed in the handleset 1000, the rack 2034 is moved linearly causing the pinion 2032 to be rotated, which in turn causes the spindle 2002 to rotate accordingly. In the depicted embodiment of FIG. 2, the rotation caused from the initial position is close to 45 degrees, which is the generally agreed standard for actuating the latch mechanism.

In the example of FIG. 2, the rack and pinion mechanism 2030 is enclosed between the plate 2020 and a back casing 2050. Skilled persons will readily recognize that other means could be used to ensure cohesion of the spindle actuator 2000. As depicted, the casing 2050 is maintained with the plate 2020 using tabs 2052 inserted into corresponding openings 2022 before being twisted-locked in place.

A return mechanism 2040 may be provided for returning the spindle to the initial position when no pressure is exerted on the first (e.g., RH configuration) or second (e.g., LH configuration) thumb-operated lever receiver 2010 or 2012. When installed into the handleset 1000, the return mechanism 2040 also provides a positive pressure during operation of the thumb-operated lever 1212. In the depicted example, two compression springs 2042 and 2043 are provided in contact with a central wall 2044 of the casing 2050 and receiving portions 2046 and 2048 respectively of the pinion 2034. The central wall 2044 may be made by punching-up a corresponding portion of the casing 2050 perpendicularly thereto. This punch-up technique, while not mandatory, is simple enough for manufacturing and does not require additional material to be soldered or otherwise attached to the casing 2050.

The spindle 2002 has to be maintained in place in the spindle actuator 2000. In the depicted example, the spindle 2002 is inserted through the plate 2020, into the rack 2032. A lock portion 2006 of the spindle 2002 also extends through the casing 2050. A C-clip 2060 is used against the lock portion 2006 that ensures rotatability of the spindle 2002 while limiting longitudinal movement thereof. A bushing 2008 may be used between the plate 2020 and the spindle 2002, e.g., to limit the likelihood of water seeping around the spindle 2002.

In some embodiments, the spindle 2002 provides an interior handle actuator portion 2004 configured to match a corresponding receiving mechanism 1120 in the interior escutcheon 1100 for the door latch to be operated from the thumb-operated lever without movement of an interior door knob or handle.

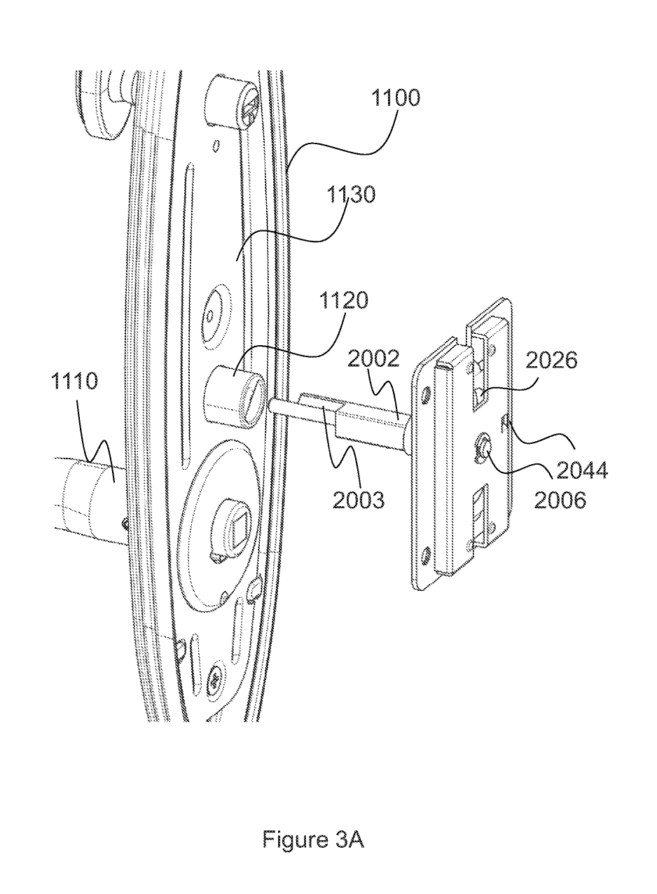

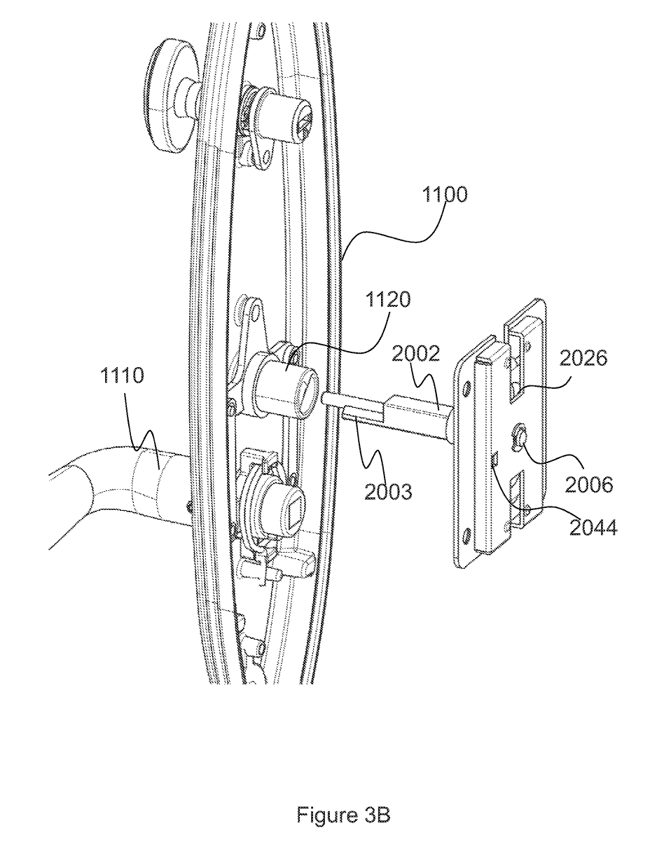

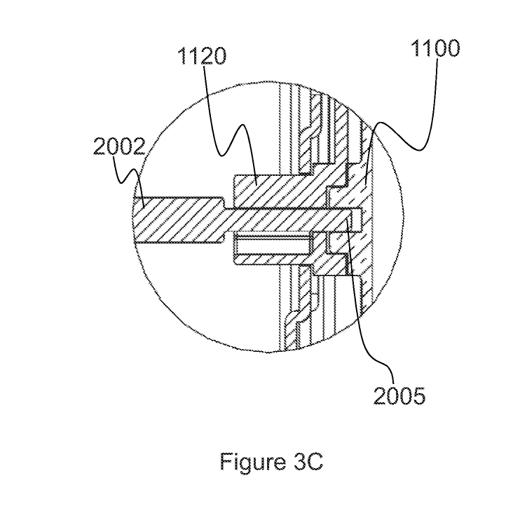

FIG. 3 provides different views of the exemplary spindle actuator 2000 configured to be received in the interior escutcheon 1100 in accordance with the teachings of the present invention. FIG. 3A shows the spindle actuator 2000 aligned with the receiving mechanism 1120 in the interior escutcheon 1100 for a right-hand configuration. FIG. 3B shows the spindle actuator 2000 aligned with the receiving mechanism 1120 in the interior escutcheon 1100 for a left-hand configuration. FIG. 3C shows a right-side cut view of the spindle actuator 2000 inserted into the receiving mechanism 1120 in the interior escutcheon 1100 for a right-hand configuration. As depicted in the example of FIG. 3C, the interior handle actuator portion 2004 comprises a needle portion 2005 that is inserted all the way towards the interior escutcheon 1100.

As can be appreciated in the example of FIG. 3, the receiving mechanism 1120 in the interior escutcheon 1100 is not modified, whether the handset 1000 is in a right-hand or left-hand configuration. The spindle actuator 2000 is turned 180 degrees along the axis of the spindle 2002 to toggle between the right-hand configuration and the left-hand configuration. In some embodiment, as depicted, the receiving mechanism 1120 is D-shaped, which allow an active wing 2003 of the interior handle actuator portion 2004 to selectively engage the receiving mechanism 1120. More specifically, as exemplified, the active wing 2003 is single-sided on the needle portion 2005 of the interior handle actuator portion 2004 thereby selectively engaging the D-shaped receiving mechanism 1120 when the handle 1110 is operated, but not when the spindle 2002 is rotated from the exterior thumb-operated lever 1212.

For all the examples relevant to FIG. 3, the handle 1110 is presumed installed on the handleset 1000 pointing towards the hinges of the door. With particular reference to FIG. 3A, when the handle 1110 is operated (i.e., pushed down) in the right-handed configuration, the receiving mechanism 1120 is rotated clockwise (as seen from the exterior perspective), engaging an active wing 2003 of the interior handle actuator portion 2004, thereby causing the spindle 2002 to rotate. Still in the right-handed configuration, when the thumb-operated lever 1212 is operated the spindle 2002 rotates accordingly, but the active wing 2003 does not engage the receiving mechanism 1120, thereby ensuring that the handle 1110 remains passive.

With particular reference to FIG. 3B, when the handle 1110 is operated (i.e., pushed down) in the left-handed configuration, the receiving mechanism 1120 is rotated counter-clockwise (as seen from the exterior perspective), engaging the active wing 2003 of the interior handle actuator portion 2004, thereby causing the spindle 2002 to rotate. Still in the left-handed configuration, when the thumb-operated lever 1212 is operated the spindle 2002 rotates accordingly, but the active wing 2003 does not engage the receiving mechanism 1120, thereby ensuring that the handle 1110 remains passive.

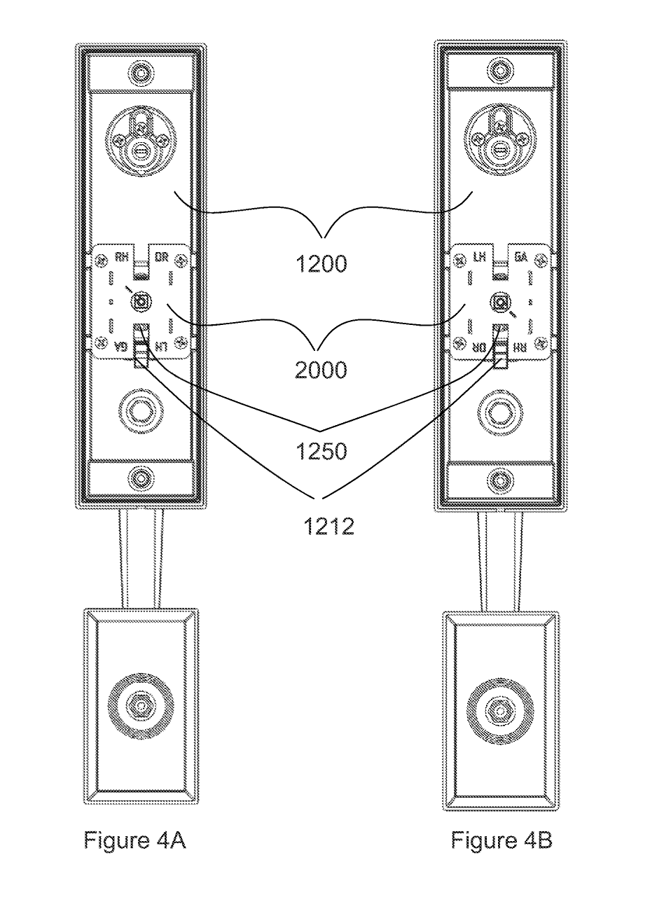

FIG. 4A is a back view of the handleset 1000 incorporating the installed exemplary spindle actuator 2000 in a right-handed configuration. FIG. 4B is a back view of the handleset 1000 incorporating the installed exemplary spindle actuator 2000 in a left-handed configuration.

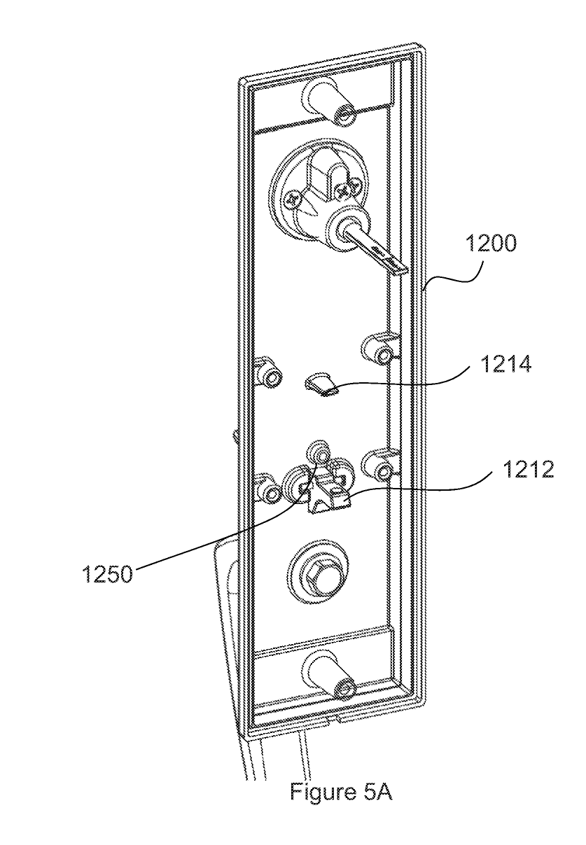

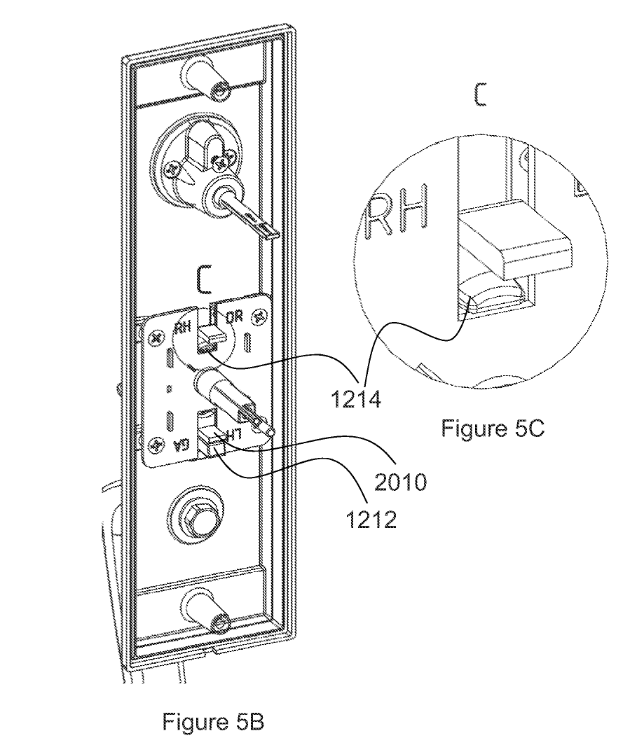

FIG. 5A, FIG. 5B and FIG. 5C, herein referred to concurrently as FIG. 5, are different interior views of the exterior escutcheon 1200 in accordance with the teachings of the present invention. An optional protuberance 1214 is provided in alignment with a corresponding opening 2026 in the spindle actuator 2000 between the rack 2034 and the plate 2020. The protuberance 1214 may prevent inadvertent (e.g., activated during or prior to installation of the handleset 1000 on a door) or malfunction (e.g., because of inverted installation of the spindle 2002 in the spindle actuator 2000) of the spindle actuator 2000 that would cause the thumb-operated lever 1212 to be moved oppositely from its normal movement. The protuberance 1214 may also help ensuring proper alignment of the spindle actuator 2000 during toggle of configuration or during installation in the exterior escutcheon 1200.

The spindle actuator 2000 could be made in different material. Following experiments, it has been determined that heat-treated steel was effective for the pinion 2034 while investment casting was proper for the pinion 2032 and the spindle 2002 and zinc-plated steel for the other elements thereof. Other manufacturing techniques could also be used instead of the punching and/or casting suggested herein. For instance, the spindle 2002 could be machine instead of being casted (e.g., wing 2003 being soldered to the needle 2005). Of course, skilled persons will readily recognize that the invention does not depend on the material used and that the other suitably-selected material (plastic, other metals, etc.) could be used without affecting the teachings of the present invention.

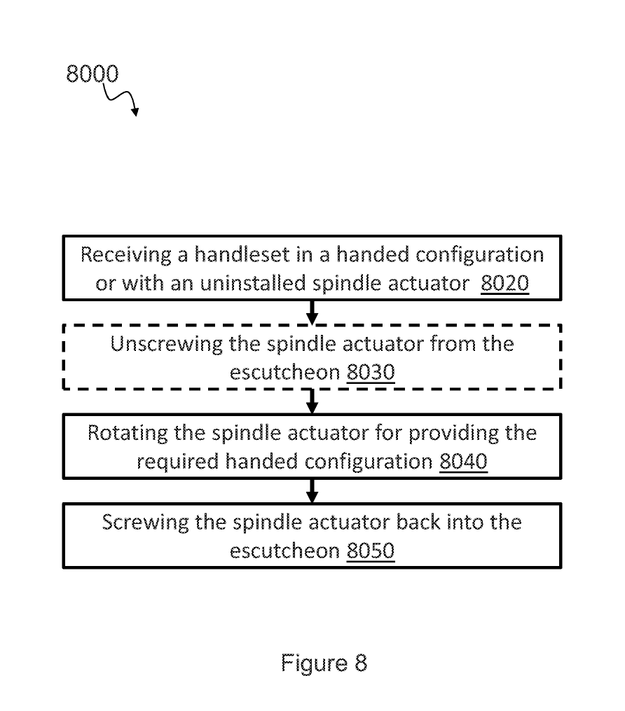

FIG. 8 shows a flow chart of an exemplary method 8000 for modifying the handed configuration of a handleset comprising a spindle actuator in accordance with the teachings of the invention. The handleset is received 8020 in a kit comprising an interior escutcheon and an exterior escutcheon with the spindle actuator installed therein in a first handed configuration or with an uninstalled spindle actuator. The exterior escutcheon comprises a thumb-operated lever for operating the handleset. The spindle actuator has two thumb-operated lever receivers, a first one for rotating a spindle of the spindle actuator in a first direction and a second one for rotating the spindle in a second direction different from the first direction. When the spindle actuator is pre-installed in the required handed configuration, the handleset is ready to be installed (not shown) conventionally. When the spindle actuator is pre-installed, but not in the required handed configuration, the spindle actuator is unscrewed 8030 from the exterior escutcheon of the handleset. Whether provided uninstalled or whether is has just been unscrewed, the spindle actuator is then rotated 8040 over the exterior escutcheon along the spindle axis for providing the required handed configuration. Once properly positioned, the spindle actuator is screwed 8050 back into the exterior escutcheon. The handleset is ready to be installed (not shown) conventionally. It is assumed that the handleset is received 8020 not in a dummy configuration. However, should it be the case, a previous step of removing (not shown) any lock screws from the handleset may be required.

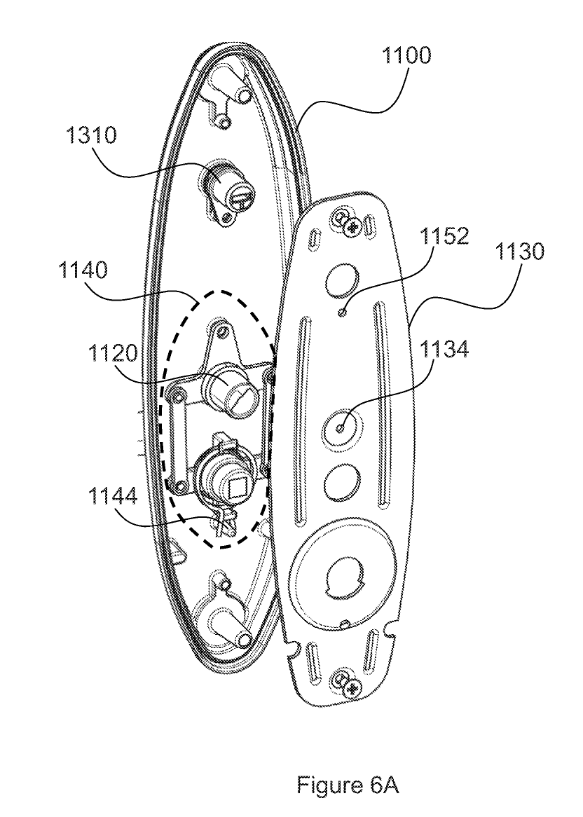

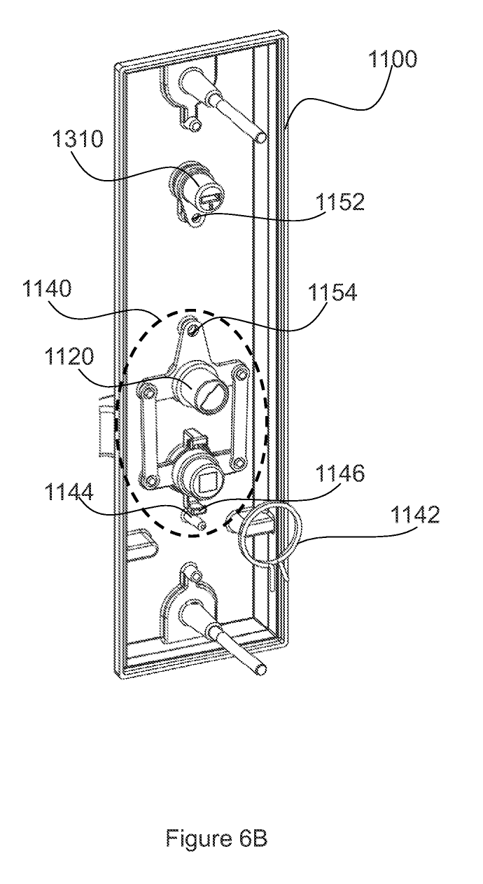

In accordance with a second set of embodiments of the present invention, FIG. 6 shows perspective views of an exemplary interior escutcheon 1100 of a handleset. Specifically, in accordance with the teachings of the second set of embodiments, the interior escutcheon 1100 incorporates an interior handle actuator 1140, which comprises a receiving mechanism 1120 for a door latch to be operated from an interior door knob or handle. A torsion spring 1142 is provided in the interior handle actuator 1140 for returning the inner handle or knob to its original position when released, thereby. An inner plate 1130 is used in the example of FIG. 6 to ensure that the interior handle actuator 1140 is properly maintained in the interior escutcheon 1100. The inner plate 1130, or at least a portion thereof (not shown) covering the interior handle actuator 1140, is required for ensuring that the torsion spring 1142 functions properly (e.g., on the correct spring coil axis without flipping sideways). In the example of FIG. 6, the torsion spring 1142 is mounted between a spring bracket 1144 of the interior escutcheon 1100 and a spring receiver 1146 functionally connected to the receiving mechanism 1120. The bracket 1144 being present in the interior escutcheon 1100 allows the use of a torsion spring 1142, which is meant to simplify manufacturing and improve reliability of the handleset by removing more complex spring-loaded components for the same purpose.

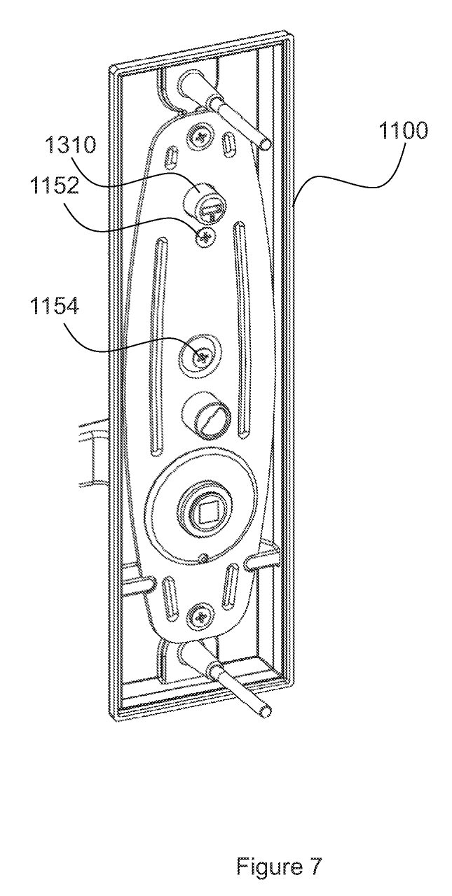

In accordance with a third set of embodiments of the present invention, FIG. 7 shows a perspective view of an exemplary handleset comprising an interior escutcheon 1100. Reference is now concurrently made to FIGS. 6A, 6B and 7, which show an interior escutcheon 1100 with features compatible with the third set of embodiments of the present invention and to FIGS. 4A, 4B, 5A, which show an exterior escutcheon 1200 with features compatible with the third set of embodiments of the present invention. Specifically, in accordance with the teachings of the third set of embodiments, the handleset can be converted completely or partially from an active handleset to a passive handleset. As depicted, a lock screw receiver 1154 may be provided in the interior escutcheon 1100 and an interior handle actuator 1140. A plate 1130 may also comprise an opening 1134 aligned with the lock screw receiver 1154. The opening 1134 may be smaller or larger than the actual expected screw or may also only be a marker indicating where the plate 1130 is to be perforated to reach the lock screw receiver 1154. Once a lock screw is inserted in the lock screw receiver 1154, the interior handle actuator 1140 is immobilized, preventing the interior handle 1110 from moving.

A lock screw receiver 1152 may also be provided in the interior escutcheon 1100 and an interior lock knob 1310. The plate 1130 may also comprise an opening 1132 aligned with the lock screw receiver 1152. The opening 1132 may be smaller or larger than the actual expected screw or may also only be a marker indicating where the plate 1130 is to be perforated to reach the lock screw receiver 1152. Once a lock screw is inserted in the lock screw receiver 1152, the interior lock knob 1310 is immobilized, preventing the interior lock knob 1310 from moving.

A lock screw receiver 1250 may also be provided in the exterior escutcheon 1200 and through a spindle actuator 2000. Once a lock screw is inserted in the lock screw receiver 1250, the spindle actuator 2000 is immobilized, at least in an active direction, preventing a thumb-operated lever 1212 from moving. The optional protuberance 1214 may also prevent movement of the spindle actuator 2000 that would cause the thumb-operated lever 1212 to be moved oppositely from its normal movement.

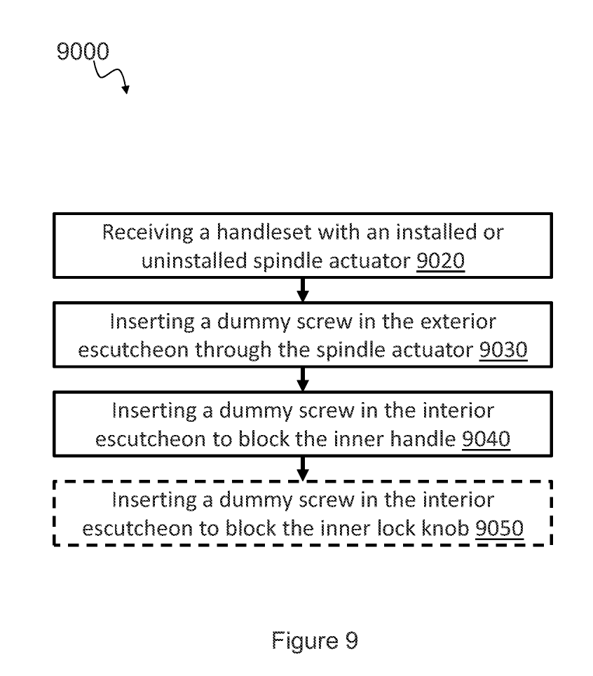

FIG. 9 shows a flow chart of an exemplary method 9000 for modifying a handleset into a dummy configuration, the handleset comprising a spindle actuator in accordance with the teachings of the invention. The handleset is received 9020 in a kit comprising an interior escutcheon with an interior handle or knob and an exterior escutcheon with the spindle actuator installed therein or with an uninstalled spindle actuator. The exterior escutcheon comprises a thumb-operated lever for operating the handleset. Necessary lock screw(s) may be provided with the handleset kit. When the spindle actuator is pre-installed, a first lock screw is inserted 9030 in the exterior escutcheon through the spindle actuator, thereby blocking the spindle actuator. A second lock screw is also inserted 9040 in the interior escutcheon for blocking the interior handle or knob thereof. A third lock screw may also be inserted 9050 in the interior escutcheon for blocking an interior lock knob thereof. It should readily be understood that the order in which the lock screws are inserted 9030, 9040 and optionally 9050 does not affect the way in which the invention works. The second lock screw when inserted 9040 may also block the interior lock knob at the same time. In some cases, it may be sufficient to block movements of the parts on only one of the exterior and interior escutcheons. The handleset in the dummy configuration is then ready to be installed (not shown) conventionally. It is assumed that the handleset is received 9020 not in a dummy configuration. However, should it be the case, the handleset would be ready for conventional installation (not shown).

Skilled persons will readily understand that the present invention relates to different improvements to improve inventory management (e.g., by providing a single boxed configuration modifiable at the time of installation into the require handed configuration and/or dummy configuration) and/or manufacturing and/or reliability of parts of a handleset kit and/or the handleset kit itself. It will also be readily appreciated that the first, second and third sets of embodiments of the present invention may be provided together in a given handleset. However, the different sets of embodiments are independent and may be provided alone or in some groups. Elements which may be determined to be essential from the description in one set of embodiments should not be determined to be essential in other set(s) of embodiments. The claims properly construed shall determine the essential elements of the invention.

The description of the present invention has been presented for purposes of illustration but is not intended to be exhaustive or limited to the disclosed embodiments. Depicted elements in the drawings are not necessarily drawn to scale. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A reversible handleset spindle actuator configured to be installed between an exterior escutcheon of a handleset and an interior escutcheon of the handleset, the reversible handleset spindle actuator comprising:
a first thumb-operated lever receiver positioned to be engaged by a thumb-operated lever connected to an exterior escutcheon of the handleset when the actuator is installed in the handleset configured for a right-handed position;
a second thumb-operated lever receiver positioned to be engaged by the thumb-operated lever connected to the exterior escutcheon of the handleset when the actuator is installed in the handleset configured for a left-handed position;
a spindle for operating a latch mechanism;
a rack and pinion mechanism for:
rotating the spindle, from an initial position, in a first direction when the first thumb-operated lever receiver is moved longitudinally towards the spindle; and
rotating the spindle, from the initial position, in a second direction different from the first direction when the second thumb-operated lever receiver is moved longitudinally towards the spindle.

2. The reversible handleset spindle actuator of claim 1 further comprising a return mechanism for returning the spindle to the initial position when no pressure is exerted on the first thumb-operated lever receiver and when no pressure is exerted on the second thumb-operated lever receiver.

3. The reversible handleset spindle actuator of claim 2, wherein the return mechanism comprises two springs oppositely mounted on a central wall of a casing of the spindle actuator, each spring respectively engaging one of two receiving portions of a pinion of the rack and pinion mechanism.

4. The reversible handleset spindle actuator of claim 1, wherein the spindle further comprises an active wing, on a one half of a needle portion thereof, for allowing a handle of the handleset connected on the interior escutcheon to actively rotate the spindle while allowing the handle to remain passive when an active one between the first and second thumb-operated lever receivers is moved longitudinally towards the spindle.

5. The reversible handleset spindle actuator of claim 1, wherein two symmetrical openings are provided therethrough for allowing a protuberance in the exterior escutcheon to get within a first one of the two openings when the spindle actuator is installed in the handleset, thereby preventing an inactive one between the first and second thumb-operated lever receivers from moving longitudinally towards the spindle.

6. The reversible handleset spindle actuator of claim 5, wherein a second one of the two openings allows a screw to be inserted towards a receiving socket in the exterior escutcheon for providing a dummy configuration of the exterior escutcheon whereby both the first and second thumb-operated lever receivers are prevented from moving longitudinally towards the spindle.

7. A method for positioning a reversible handleset spindle actuator in a handleset for providing a required handed configuration for the handleset, the method comprising:
receiving the handleset, wherein the reversible handleset spindle actuator is pre-installed providing a first handed configuration for the handleset or wherein the handleset spindle actuator is uninstalled, the spindle actuator comprising a first thumb-operated lever receiver for rotating a spindle of the spindle actuator in a first direction and a second thumb-operated lever receiver for rotating the spindle in a second direction different from the first direction;
when the spindle actuator is pre-installed in the first handed configuration different from the required handed configuration, unscrewing the spindle actuator from the exterior escutcheon of the handleset;
rotating the spindle actuator over the exterior escutcheon along the spindle axis for providing the required handed configuration; and
once properly positioned, screwing the spindle actuator into the exterior escutcheon.

8. A handleset kit comprising:
an interior escutcheon:
an exterior escutcheon; and
a reversible handleset spindle actuator configured to be installed between the exterior escutcheon and the interior escutcheon, the reversible handleset spindle actuator comprising:
a first thumb-operated lever receiver positioned to be engaged by a thumb-operated lever connected to an exterior escutcheon of the handleset when the actuator is installed in the handleset configured for a right-handed position;
a second thumb-operated lever receiver positioned to be engaged by the thumb-operated lever connected to the exterior escutcheon of the handleset when the actuator is installed in the handleset configured for a left-handed position;
a spindle for operating a latch mechanism;
a rack and pinion mechanism for:
rotating the spindle, from an initial position, in a first direction when the first thumb-operated lever receiver is moved longitudinally towards the spindle; and
rotating the spindle, from the initial position, in a second direction different from the first direction when the second thumb-operated lever receiver is moved longitudinally towards the spindle.

9. The kit of claim 8, wherein the reversible handleset spindle actuator further comprises a return mechanism for returning the spindle to the initial position when no pressure is exerted on the first thumb-operated lever receiver and when no pressure is exerted on the second thumb-operated lever receiver.

10. The kit of claim 9, wherein the return mechanism comprises two springs oppositely mounted on a central wall of a casing of the spindle actuator, each spring respectively engaging one of two receiving portions of a pinion of the rack and pinion mechanism.

11. The kit of claim 8, wherein the spindle further comprises an active wing, on a one half of a needle portion thereof, for allowing a handle of the handleset connected on the interior escutcheon to actively rotate the spindle while allowing the handle to remain passive when an active one between the first and second thumb-operated lever receivers is moved longitudinally towards the spindle.

12. The kit of claim 8, wherein the reversible handleset spindle actuator further comprises two symmetrical openings provided therethrough for allowing a protuberance in the exterior escutcheon to get within a first one of the two openings when the spindle actuator is installed in the handleset, thereby preventing an inactive one between the first and second thumb-operated lever receivers from moving longitudinally towards the spindle.

13. The kit of claim 12, wherein a second one of the two openings allows a screw to be inserted towards a receiving socket in the exterior escutcheon for providing a dummy configuration of the exterior escutcheon whereby both the first and second thumb-operated lever receivers are prevented from moving longitudinally towards the spindle.

14. The kit of claim 8, wherein the interior escutcheon further comprises a first lock screw receiver for receiving a lock screw for preventing an interior handle actuator from moving.

15. The kit of claim 14, wherein the interior escutcheon further comprises a second lock screw receiver for preventing an interior lock knob from moving.

16. The kit of claim 15, wherein the interior escutcheon further comprises a plate comprising one or more indications aligned with at least one of the first and second lock screw receivers.
